(19) United States
(12) Patent Application Publication
(10) Pub. No.: US 2025/0119512 A1
(43) Pub. Date: Apr. 10, 2025

(54) SYSTEM AND METHOD FOR PERSONAL AND PUBLIC SAFETY MONITORING

(71) Applicant: Etheric Mc Farlane, Portland, OR (US)

(72) Inventor: Etheric Mc Farlane, Portland, OR (US)

(21) Appl. No.: 18/413,871

(22) Filed: Jan. 16, 2024

Related U.S. Application Data
(60) Provisional application No. 63/542,517, filed on Oct. 4, 2023.

(51) Int. Cl. H04N 7/18; H04N 23/54

(52) U.S. Cl. CPC H04N 7/185; H04N 23/54

(57) ABSTRACT

A System And Method for Personal And Public Safety Monitoring System, secured to a backpack camera, storage of video content in a (cloud based) website and combined desktop and tablet personal computer is provided. The system comprises libraries of A.I. software, a backpack with multiple cameras, and a storage location in a (cloud based) website and combined desktop and tablet personal computer. One embodiment comprises a processor system, a camera communicatively coupled to the processor system, a wireless transceiver communicatively coupled to the processor, and at least one sensor wherein a sensor communicates a signal to the processor that indicates that the user is activating through voice command; wherein the processor system activates the camera to acquire video content in response to receiving the signal from at least one sensor that detects voice activation, that indicates that the user is operating through voice command.

### CROSS REFERENCE TO RELATED APPLICATIONS

This application claims priority to co-pending U.S. Provisional Application No. 63/542,517, filed on Oct. 4, 2023, which is hereby incorporated by reference for all purposes.

### BACKGROUND

The invention is directed to a system for monitoring activities and events to enhance personal and public safety. One example of such a system is a body camera or personal video recording system. The body camera includes a video image capture device. A non-limiting example is a video camera, a microphone, and memory for storing acquired video, audio content, and other data. The body camera is typically secured to uniform clothing worn by public law enforcement or private security officers.

Another example is private citizen cellular phone recordings of citizen-on-citizen encounters. Citizens have been using their cellular phone video recorders to capture incidents between citizens during public disagreements. For years, African Americans have been accused of crimes with no other means to prove their innocence other than their own word. However, recently, video recordings have become a popular tool for collecting a record of an incident, from the beginning to the end, proving their innocence. These encounters have occurred in public parks, shopping malls, and schools, to mention a few. Although useful, cellular phones have limitations: (1) the citizen must have the cell phone on his person; (2) the citizen must have access to the phone during the incident; (3) the citizen must activate the video/audio features of the phone, which may be challenging to do under stress; (4) use of the cell phone may be denied by physical action by the adverse party, such as slapping the cell phone away which may damage the phone and cause a loss of the recording or making retrieval difficult and expensive. Thus, cell phones are less useful than body camera systems for recording incidents.

However, the body camera systems have not been expanded to cover citizen activity to aid the citizen while interacting with people or participating in various areas of life to memorialize video and/or audio information of the activity of the wearer, e.g., going to school, work, or an unpleasant conversation. The invention provides a means and system to live stream or record, store, and later transmit audio-visual information.

Furthermore, the invention connects citizens to a communication network that facilitates live streaming or transmitting stored audio-visual information. Additionally, the communication network connects the citizens to various services, such as emergency or convenience services. Lastly, the communication network facilitates two-way communication via a linked cellular phone or wireless communication over the Internet.

Moreover, school-aged citizens need a method to assist them if they happen to be being bullied at school or mistreated by someone on the way to or from school. In addition to recording and transmitting audio-visual data, the software will automatically activate and acquire audio-visual information when stressors are present. Stressors include elevated voices, screams, gunshots, aggressive motions, or gestures. Automatic activation assists school-age children who may not have the contentiousness to turn on the invention when needed; it also helps citizens when stressors arise unexpectedly. Lastly, the invention can assist youth, families, and law enforcement as a kidnap prevention deterrent by including a global positioning system (GPS). Thus, there exists a need to provide body camera systems to enhance the personal and public safety of private citizens.

### SUMMARY OF THE INVENTION

The invention is a backpack worn by the citizen and is designed to function like a body camera. The backpack has a wireless camera, speakers, and a microphone. These devices are coupled to a computing device stored within the backpack. The computing device provides a system and method for acquiring audio-visual data (hereinafter “A.V. data”). The A.V. data is either live-streamed or stored. Additionally, the computing device provides two-way communication of audio only or A.V. data via a connected cellular phone or other wireless network.

The computing device is connected to a communication network. The communication network may be cloud-based or another available wireless network. Via the communication network, the invention will transmit the A.V. data or audio data to another targeted website or device that will upload the data from the communication network. Lastly, the communication network facilitates two-way audio or A.V. data communication to a third party, such as another public safety officer, emergency services, negotiator, or convenience services.

### BRIEF DESCRIPTION OF THE DRAWINGS

FIG. 1 is the rear side of the invention.

FIG. 2 is the left-hand side of the invention.

FIG. 3 is the forward-facing side of the invention.

FIG. 4 is the right-hand side of the invention.

FIG. 5 is a block diagram of the invention.

FIG. 6 is a block diagram of the devices with which the invention can communicate.

### DETAILED DESCRIPTION

The invention is a backpack meant to be worn by the user. The backpack includes hardware to record A.V. data or audio data and transmit the A.V. data or audio data wirelessly via a communication network. A computing device that runs software operates the hardware and interfaces with the wireless communication with the network is carried within the backpack.

The disclosed systems and methods for a System and Method for Personal and Public Safety Monitoring will be better understood by reviewing the following detailed description in conjunction with the figures. The detailed description and figures provide examples of the various inventions described herein. Those skilled in the art will understand that the disclosed examples may be varied, modified, and altered without departing from the scope of the inventions described herein. Many variations are contemplated for different applications and design considerations; however, for the sake of brevity, each and every contemplated variation is not individually described in the following detailed description.

Throughout the following detailed description, a variety of examples of systems and methods for a public safety monitoring system are provided. Related features in the examples may be identical, similar, or dissimilar in different examples. For the sake of brevity, related features will not be redundantly explained in each example. Instead, using related feature names will cue the reader that the feature with a related name may be similar to the related feature in an example explained previously. Features specific to a given example will be described in that particular example. The reader should understand that a given feature need not be the same or similar to the specific portrayal of a related feature in any given figure or example.

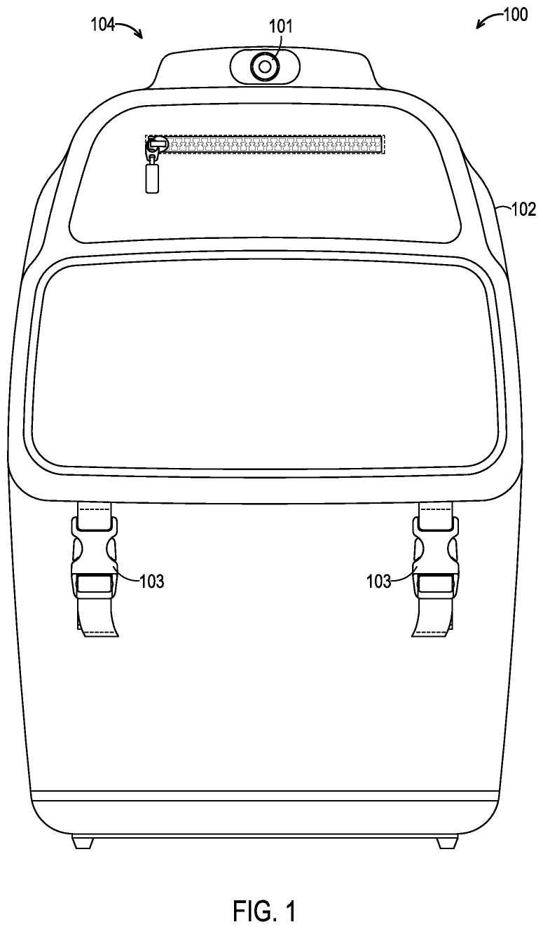

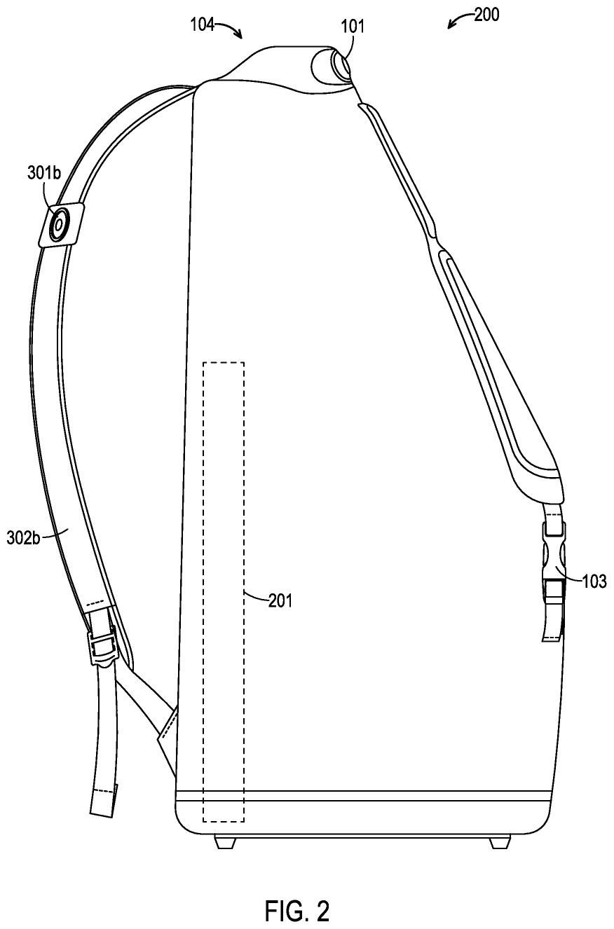

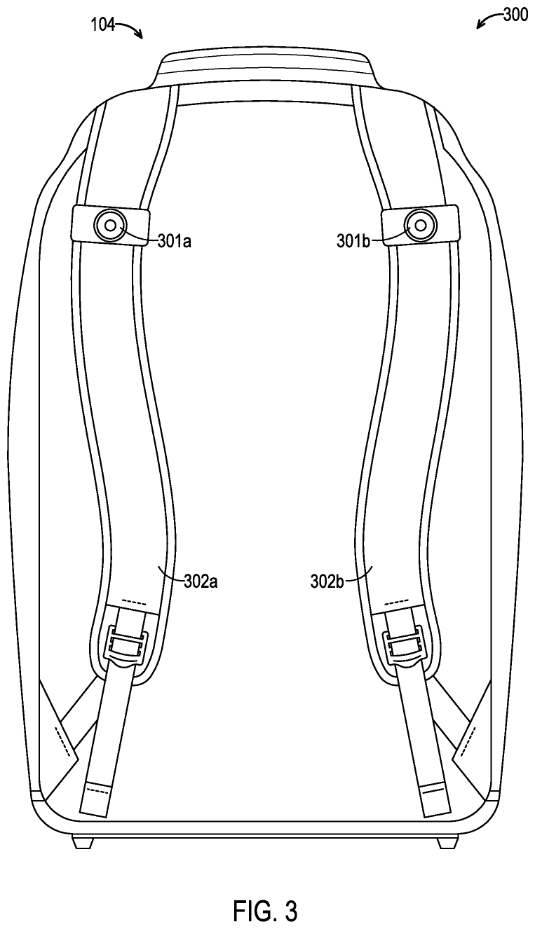

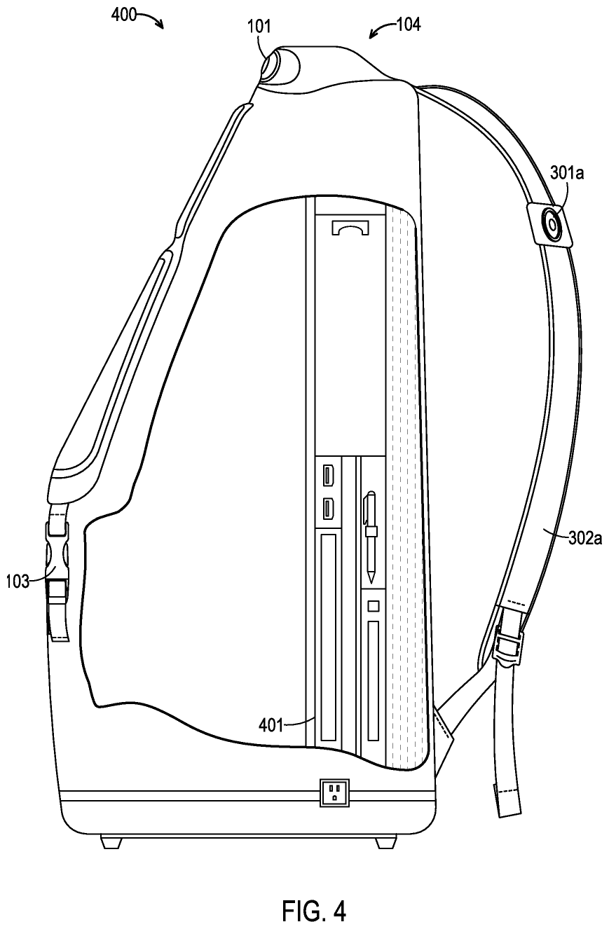

Referring to FIGS. 1-5, the invention (100) is a backpack designed to be worn on the shoulders, with a closure flap (102), buckles (103) to secure the flap (102), and a camera case (104), a storage compartment (201). Additionally, the backpack has right (302a) and left (302b) shoulder straps. The backpack is equipped with the following hardware: a rear-facing camera (101), and two forward-facing cameras (301a and 301b) secured to the right (302a) and left (302b) shoulder straps, a microphone (505), a speaker (506), and wireless transceivers (508 and 509). In the preferred embodiment, the device is carried in the backpack. In one embodiment, the device is a minicomputer (401) that can run Android, Microsoft Windows, Apple IOS, or any operating system capable of running program applications that acquire, store, and transmit data. Another non-limiting device example is the Tablet P.C. (603a or Tablet plus Desktop 603b) disclosed in U.S. 00B706258S of Jun. 3, 2014, incorporated by reference for all purposes.

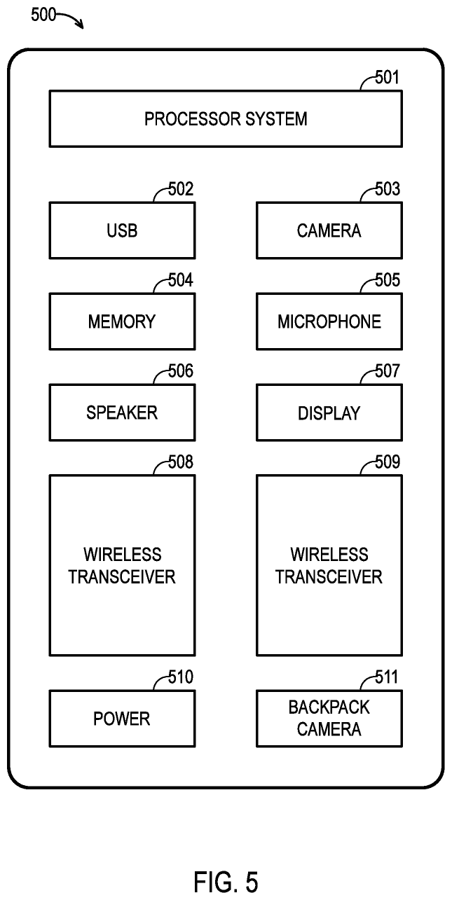

FIG. 5 is a block diagram (500) of the invention which comprises a processor system (501), a USB port (502), a camera (101, 301a, and 301b) a backpack (100), a memory (504), a microphone (505), a speaker (506), a display (507), wireless transceivers (508 and 509) and a power source (510). The cameras (101, 301a, and 301b), microphone (505), speaker (505), display (507), and wireless transceivers (508 and 509) are communicatively coupled to the processor system.

Installed software operates the hardware that acquires the data, stores or live streams the data, facilitates two-way communication with third parties, and interfaces with the communication network (600) via the wireless transceivers (508 and 509). Furthermore, the processor has artificial intelligence software that recognizes stressors such as aggressive gestures hand and arm movements. Additionally, it recognizes stressors such as voice tones; it can categorize anger vs. calm or loud laughter vs. a scream. Other stressors could include gunshots or pattern recognition of shapes of dangerous devices such as knives, clubs, baseball bats, hammers, handguns, rifles, or shotguns. Once a stressor is detected, the software automatically activates the cameras, microphones, and speakers to acquire the data. The data may be stored in memory or be live streamed. The software can also be voice-activated to receive commands, such as to start or stop data collection.

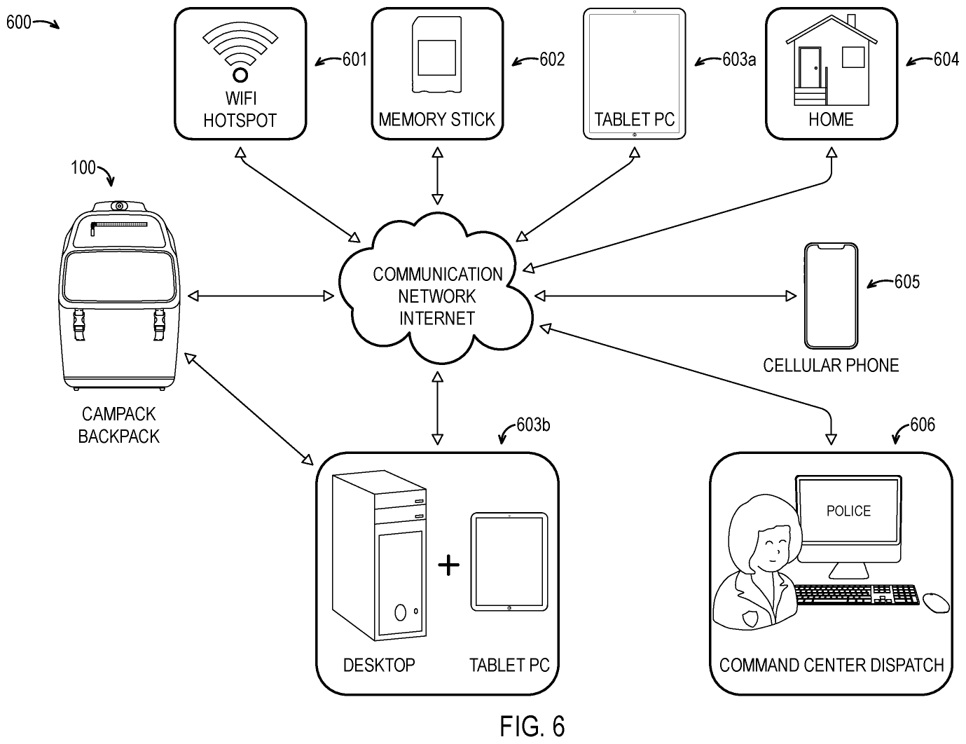

The software interfaces with a wireless communication network (600) to live stream data, transmit stored data, or allow the wearer to communicate with third parties. Non-limiting examples of the communication network are provided in FIG. 6. The communication network (600) may include a Wi-Fi Hotspot (601), a memory stick (602), the Tablet P.C. (603a or 603b), a home-based network (604), a cellular phone (605) or public services with a non-liming example being a dispatch center (606).

The communication network may be any method of transmitting audio or data; non-limiting examples include telephony system, the Internet, a Wi-Fi system, Bluetooth, a near-field communication system, a microwave communication system, a fiber optic system, an intranet system, a local access network (LAN) system, an Ethernet system, a cable system, a radio frequency system, a cellular system, an infrared system, a satellite system, a cloud computing system, or a hybrid system comprised of multiple types of communication media.

Other modes of transmission by the communication network may be implemented to communicate using technologies, such as but not limited to, digital subscriber loop (DSL), X.25, Internet Protocol (I.P.), Ethernet, Integrated Services Digital Network (ISDN) and asynchronous transfer mode (ATI), and 4G/5G wireless networks.

Commencing the acquisition of A.V. data or audio can be automatic or by voice command. When a stressor is detected, the acquisition of A.V. data or audio data automatically begins. The acquired data may be live-streamed or stored. Live streaming may be sent to a targeted website or a designated third party, such as a command dispatcher (606). The acquired data may be stored in the memory (504) and/or transmitted via the communication network (600) to another storage location. Non-limiting examples of such locations include a memory stick (602), a home-based networked computer (604), or the Tablet P.C. (610a or 610b).

In one embodiment, the acquired data is stored in the memory (504). The stored data can then be transferred via the communication network (600) by the user or automatically transferred once the device connects to a communication network. For example, transmission may begin once a Wi-Fi hotspot (601) is available.

In the preferred embodiment, the communication network is a cellular telephone system (605). The software accesses and interfaces with the phone's applications (hereinafter, “App”), allowing the software to operate the phone and use the applications stored on the phone; for example, the software could transmit data using the cell phone hotspot App or access the GPS App and transmit the location of the citizen, or make calls to third parties using the phone.

In another embodiment, the invention can de-escalate encounters between civilians and law enforcement. The software can call a command or dispatch center (606) via the communication network. Once connected via the communication network (600), a superior officer or negotiator can become involved and communicate with the parties via the microphone (505) and speaker (506). Two-way communication can include visual communication, too. An intervention by a third party can help to de-escalate encounters between civilians and law enforcement. The software activation could be by voice command or by detecting a stressor.

When worn, the backpack has a forward-facing side and a rearward facing side. The forward-facing side is the side that faces in the direction of travel of the user and generally follows the natural line of sight of the user. Under typical use, the right (302a) and left (302b) shoulder straps and cameras 301a and 301b would face forward and camera 101 would face rearward.

The subject matter of the inventions includes all novel and non-obvious combinations and sub-combinations of various elements, features, functions, and/or properties disclosed above and inherent to those skilled in the art pertaining to such inventions. Where the disclosed or subsequently filed claims recite “a” element, “a first” element, or any such equivalent term, the disclosure or claim should be understood to incorporate one or more such elements, neither nor excluding two or more such elements.

Applicant reserves the right to submit claims directed to combinations and sub-combinations of the disclosed inventions that are believed to be novel and non-obvious. Inventions embodied in combinations and sub-combinations of features, functions, elements, and/or properties may be claimed through amendment of those claims or presentation of new claims in the present application or in a related application. Such amendment or new claims, whether they are directed to the same invention or a different invention and whether they are different, broader, narrower, or equal in scope to the original claims, are to be considered within the subject matter of the invention described herein.

### Definitions

The following definitions apply herein unless otherwise indicated.

“Application or App” means software programs developed for end-users to accomplish specific computing tasks using personal computers, minicomputers, or mobile devices.

“Comprising,” “including,” and “having” (and conjugations thereof) are used interchangeably to mean including but not necessarily limited to and are open-ended terms not intended to exclude additional elements or method steps not expressly recited.

Terms such as “first”, “second”, and “third” are used to distinguish or identify various members of a group, or the like, and are not intended to denote a serial, chronological, or numerical limitation.

“Coupled” means connected, either permanently or releasable, directly or indirectly, through intervening components.

“Cloud or Cloud Based” includes:
a. On-demand self-service. A consumer can unilaterally provision computing capabilities, such as server time and network storage, as needed automatically without requiring human interaction with each service provider.
b. Broad network access. Capabilities are available over the network and accessed through standard mechanisms that promote use by heterogeneous thin or thick client platforms (e.g., mobile phones, tablets, laptops, and workstations).
c. Resource pooling. The provider's computing resources are pooled to serve multiple consumers using a multi-tenant model, with different physical and virtual resources dynamically assigned and reassigned according to consumer demand.
d. Rapid elasticity. Capabilities can be elastically provisioned and released, in some cases automatically, to scale rapidly outward and inward, commensurate with demand. To the consumer, the capabilities available for provisioning often appear unlimited and can be appropriated in any quantity at any time.
e. Measured service. Cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

“Communicatively coupled” means that an electronic device is communicatively connected to another electronic device, either wirelessly or with a wire cloud-based connector, whether directly or indirectly, through a cloud-based communication network.

“Controllably coupled” means that the electronic cloud-based device controls the operation of the other electronic device.

“Interface” means software interfaces or programming interfaces that are the languages, codes, and messages that programs use to communicate with each other and to the hardware. Examples are the Windows, Mac, and Linux operating systems, SMTP email, I.P. network protocols, and the software drivers that activate the peripheral devices.

“Substantially” means more-or-less conforming to the particular dimension, range, shape, concept, or other aspect modified by the term, such that a feature or component need not conform exactly. For example, a “substantially cylindrical” object means that the object resembles a cylinder but may have one or more deviations from a true cylinder.

What is claimed is:

1. A system for monitoring public safety comprising:
A backpack, where the backpack has at least one shoulder strap, at least one interior compartment, at least one zippered pocket, a flap that covers the interior compartment, and at least one buckle that holds the flap closed; where the system further comprises at least one camera, at least one microphone, and at least one speaker; where the camera is attached to the outside of the backpack, the microphone is attached to the backpack, and the speaker is attached to the backpack; wherein the system further comprises a computing device stored in an interior compartment, wherein the computing device further comprises a processor system, a wireless transceiver, a USB port, a display, a memory, and a power supply.

2. The backpack of claim 1 where, the backpack has forward facing side and a reward facing side with respect to the direction of travel or facing of the wearer, where the shoulder strap is forward facing and a camera is attached to the shoulder strap, and where a camera is attached to the rearward facing side of the backpack.

3. The backpack of claim 2 where the processor system is communicatively coupled to the camera, the microphone, the speaker, and the wireless transceiver.

4. The processor system of claim 3 where the processor further comprises an operating system, and the operating system runs installed software.

5. The installed software of claim 4, can process voice commands, where said voice commands turn on or off the: camera, microphone, and speaker; and the software can acquire audio or audio visual data.

6. Where the installed software of claim 5 further includes artificial intelligence capabilities that recognizes stressors, and upon recognition of stressors automatically turns on the camera, microphone, and speaker and acquires audio visual data or audio data; and either stores the acquired audio or audio visual data, or transmits the audio or audio visual data.

7. Where the acquired or stored audio or audio visual data of claim 6 uploads the transmits the data via a communication network.

8. Where the communication network of claim 7 includes, a memory stick, a cell phone, a home-based computer, a Wi-Fi hotspot, or a dispatch center.

9. Where the stressors of claim 6 include, threatening gestures, threating hand and arm movements, threatening leg movements, threating voice tones, screams, gun shots, and the patterns of harmful devices.

10. Where the patterns of harmful devices of claim 9 include clubs, baseball bats, knives, swords, handguns, rifles, and shot guns.

11. A system for monitoring public safety comprising:
A backpack, where the backpack has at least one shoulder strap, at least one interior compartment, at least one zippered pocket, a flap that covers the interior compartment, and at least one buckle that holds the flap closed; where the system further comprises at least one camera, at least one microphone, and at least one speaker; where the camera is attached to the outside of the backpack, the microphone is attached to the backpack, and the speaker is attached to the backpack; wherein the system further comprises a computing device stored in an interior compartment, wherein the computing device further comprises a processor system, a wireless transceiver, a USB port, a display, a memory, and a power supply; the backpack has forward facing side and a reward facing side with respect to the direction of travel or facing of the wearer, where the shoulder strap is forward facing and a camera is attached to the shoulder strap, and where a camera is attached to the rearward facing side of the backpack; where the processor system is communicatively coupled to the camera, the microphone, the speaker, and the wireless transceiver; where the processor further comprises an operating system, and the operating system runs installed software; where the installed software can process voice commands, where said voice commands turn on or off the camera, microphone, and speaker, and the software can acquire audio or audio visual data; where the installed software further includes artificial intelligence capabilities that recognizes stressors, and upon recognition of stressors automatically turns on the camera, microphone, and speaker and acquires audio visual data or audio data and either stores the acquired audio or audio visual data, or transmits the audio or audio visual data.

12. The backpack of claim 11 where transmission is accomplished via a communication network where said communication network includes: a memory stick, a cell phone, a home-based computer, a Wi-Fi hotspot, or a dispatch center.

13. A method for public safety monitoring, comprising: (1) providing the backpack of claim 12, (2) detecting a stressor, (3) acquiring audio visual or audio data, and (3) transmitting said data via the communication network, or storing said audio visual data or audio data.

14. A method for public safety monitoring, comprising: (1) providing the backpack of claim 12, (2) providing at least two adverse parties, (3) detecting a stressor, (4) acquiring audio visual or audio data, (5) transmitting said data via the communication network to a dispatch center, (6) and where a third party at the dispatch center communicates with the adverse parties.
